(19) United States
(12) Patent Application Publication
(10) Pub. No.: US 2012/0179532 A1
(43) Pub. Date: Jul. 12, 2012

(54) DEVICE AND METHOD FOR DEVELOPING CUSTOMER LOYALTY

(75) Inventor: Thierry Vermander, Etterbeek (BE)

(73) Assignee: FIDELSYS S.A., Brussels (BE)

(21) Appl. No.: 13/395,756

(22) PCT Filed: Sep. 4, 2010
(86) PCT No.: PCT/EP10/63491

§ 371 Date: Mar. 13, 2012

(30) Foreign Application Priority Data
Sep. 14, 2009 (BE) BE2009/0563

(51) Int. Cl. G06Q 30/02

(52) U.S. Cl. 705/14.27

(57) ABSTRACT

A method and device develops customer loyalty, whereby each member is supplied with a unique identification means. The method and system has a terminal having a reader of the unique identification means provided at points of sale whereby, during a transaction at a point of sale, the terminal dispatches, to a customer loyalty development server, a message containing the identity of the member. An identity of the point of sale and/or of the affiliate and the data relating to the transaction is provided to the customer loyalty development server which allocates a number of points to a points counter in the database of the members.

### TECHNICAL DOMAIN

The invention pertains to the domain of electronic and computerized devices for developing customer loyalty and to methods using these devices, in which vendors aim to optimize the vendor/purchaser relationship and to develop loyalty in their clients. These same devices and methods can also be applied to relationships between employees and their enterprise, or to those between members of a club or of an association and this club or this association. Hereinafter, the generic terms vendors/purchasers or affiliates/members will be used to designate all these cases. An affiliate can therefore be a lone trader or a network of traders forming a brand or a commercial chain. An affiliate can comprise one or more points of sale.

### DESCRIPTION OF THE PRIOR ART

In a situation of ever greater competition, development of customer loyalty has become essential in the management of any commercial enterprise. To induce clients to return, a trader can choose between two strategies: that of managing his own loyalty program or that of teaming together in association with an existing so-called multi-brand program. Nevertheless, whatever type of program is used, studies demonstrate that none of them meets the expectations of traders and clients.

The use of loyalty cards has become widespread in recent years. Each vendor develops a tool and a strategy and supplies his clients with an identification card. One of the drawbacks of this system is that the client is rapidly in possession of a multitude of cards of each of the networks to which he has shown allegiance.

To remedy this drawback, multi-brand programs were then designed. In these systems, several vendors team together in association to offer a card and a network. However, this system also presents drawbacks: it is difficult to reconcile divergent interests of various member vendors of the network, for example when they operate in the same market.

A customer loyalty development device in which a member has a chip card on which information resides is known from document EP0786746. This information includes data 18 relating to the member and to his card, data relating to his behavior 21, and a points file 22. During a purchase from a trader, a payment terminal 2 reads the data of the card, and as a function of an algorithm residing in this terminal, decides on the allocation of points and/or the printing of a coupon for the member. This device presents certain disadvantages however. The saving of data, in particular points, presents risks of loss, and is limited in terms of volume. The location of the customer loyalty development algorithm at the payment terminal does not allow flexible management of the latter. Moreover, the member can only gain sight of his points account upon printing a coupon. He does not have an overall picture of the points that have been allocated to him and of the conditions under which they were allocated. Finally, this system is not suitable for managing a plurality of loyalty programs, for a plurality of brands. It therefore inevitably leads to the purchaser having to keep a large number of cards in his wallet, for each of the brands.

A loyalty file structure for chip cards is known from WO00/17794. This system presents the same drawbacks resulting from the presence of the loyalty data in a memory of the chip card, namely risk of loss or of theft.

Although this system can manage the loyalty programs of several vendors, the card comprises a limited and pre-set number of available loyalty files for a limited number of vendors.

An example of a multi-brand system, the “Maximiles” system, is described in document WO02/50728. It relates to a customer loyalty development system for purchases made on the Internet. In this system, the member is identified by a “cookie” residing on his computer. A member has a single points counter (Maximiles) which is incremented during each purchase on one of the affiliated sites. In this system, even if each affiliate can personalize its offer of points, as a function of the purchasing behavior of its members, it is not possible for it to personalize the type of promotions or rewards offered to its members. It cannot carry promotions such as “reduction on n^{th} purchase”.

The device known from WO02/01433 also operates according to the principle of a memory card, which contains the customer loyalty data for the purchaser (member). In this system, the electronic payment terminal (EPT) is the central element: it stores the transactions performed by purchasers; it contains and executes the customer loyalty development programs which have been downloaded to it. Each store can manage its own customer loyalty development program. Such a system does not, however, allow the flexibility of operation required in a modern customer loyalty development system, for example the possibility of modifying in real time a customer loyalty development strategy over a network of traders extending over a large scale, for example internationally.

None of the systems discussed hereinabove allows an affiliate to have an overall picture of its members, or allows an affiliate to modify in real time a customer loyalty development strategy over a network extending to a large scale. None of these systems allows its members to have an overall picture of their loyalty points acquired through affiliates of which they are a member. None of these systems allows centralized and unique updating of a member's individual data.

### SUMMARY OF THE INVENTION

The present invention is aimed at solving the prior-art limitations discussed hereinabove, and at providing a customer loyalty development device and method which are simple for the member to employ, and which allow the affiliates to define their customer loyalty development strategy in an easy and independent manner.

According to a first aspect, the invention pertains to a method for developing customer loyalty for a set of members of one or more affiliates, comprising the following steps:

allocation of a unique identification means to each member of the set;
provision of a terminal and/or adaptation of an existing terminal at the point(s) of sale of said one or more affiliates, said terminal comprising a means for acquiring the identification of the member;
provision of a customer loyalty development server able to communicate with each of said terminals, and comprising a database of the members, a database of the affiliates and a database of the customer loyalty development strategies, a customer loyalty development strategy being associated with a lone affiliate, or with a point of sale of an affiliate;
during a transaction at a point of sale, dispatching by the terminal from the point of sale to the customer loyalty development server of a message containing the identity of the member, the identity of the point of sale and/or of the affiliate and the data relating to the transaction performed;
allocation by the customer loyalty development server of a number of points to a points counter specific to the member and to the affiliate.
This points counter can reside in the member/affiliate relationship of the database which contains the databases of the members, affiliates and customer loyalty development strategies.

The method can furthermore comprise the dispatching by the customer loyalty development server of a statement message to the terminal. This message can contain the result of the loyalty strategy, for example the number of points allocated to the member.

The message and/or the statement message are advantageously lightweight asynchronous messages, that is to say messages containing only the data useful to the transaction performed.

Preferably, the unique identification means contains only the unique identification of the member to the exclusion of other data.

The unique identification means may be chosen from among the set consisting of a barcode element, a magnetic-track card, a chip card, an identity card fitted with a chip, a radio-frequency tag, biometric identification means such as the fingerprints or the iris.

Preferably, the customer loyalty development server allows an affiliate to consult and update the fraction of the database of the customer loyalty development strategies which relates to it.

Advantageously, the customer loyalty development server is able to produce and to forward to one or more members a report established regarding the number of points obtained by the member.

According to a second aspect, the invention pertains to a device for developing customer loyalty for a set of members of one or more affiliates, comprising for each member of the set a means of unique identification of this member; at each point of sale of an affiliate, a terminal comprising a means for reading the unique identification of the member; a customer loyalty development server able to communicate with each of said terminals, and comprising a database of the members, a database of the affiliates and a database of the customer loyalty development strategies; means able to dispatch, during a transaction at a point of sale, by the terminal from the point of sale to the customer loyalty development server a message containing the identity of the member, the identity of the point of sale and/or of the affiliate and the data relating to the transaction performed; means of allocation by the customer loyalty development server of a number of points to a points counter specific to the member and to the affiliate.

Preferably, the customer loyalty development server and the terminals are able to exchange lightweight asynchronous messages.

Advantageously, the means of unique identification of a member contains only the unique identification of the member to the exclusion of other data.

The identification means of the device is chosen from among the set consisting of a barcode element, a magnetic-track card, a chip card, an identity card fitted with a chip, a radio-frequency tag, biometric identification means such as the fingerprints or the iris.

Both in the method and in the device, the database of the customer loyalty development server can also contain a database of the points of sale, in particular in the case where an affiliate comprises several points of sale, and that it wishes to personalize the customer loyalty development strategies for each of its points of sale.

The invention also pertains to a computer program able to execute the fraction residing on the customer loyalty development server of the method and/or of the device in accordance with the invention, as well as to the corresponding fraction residing on a terminal.

### BRIEF DESCRIPTION OF THE DRAWINGS

FIG. 1 is a basic diagram of a customer loyalty development device in accordance with the invention.

FIG. 2 is an entity-relationship chart representative of the structure of the databases residing on the customer loyalty development server.

FIG. 3 is a flowchart representing the procedure executed when a transaction is performed at a point of sale belonging to a device in accordance with the invention.

FIG. 4 is a block diagram representing the architecture of the software components used in an embodiment of a device of the invention.

### DETAILED DESCRIPTION OF THE INVENTION

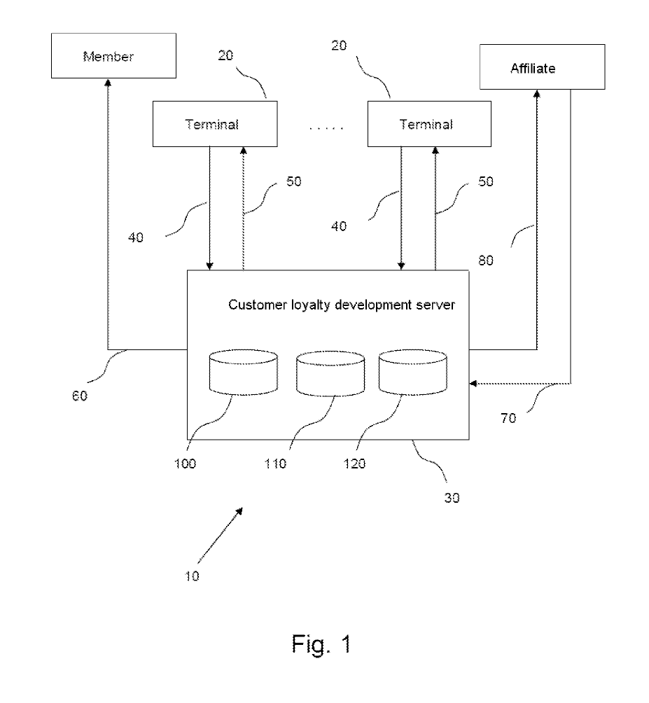

FIG. 1 represents in a schematic manner the architecture of a customer loyalty development system 10 in accordance with the invention. At each point of sale forming part of the system, a terminal 20 is installed. This terminal may be a terminal specially designed for the application, but is advantageously a personal computer. In this case, it is not necessary to add a new item of equipment to the point of sale, when the latter already has a personal computer. It suffices, if appropriate, to add a barcode reader for example. The terminal 20 is capable of exchanging messages 40, 50 with a customer loyalty development server 30 installed in a centralized manner.

These messages are advantageously Internet transactions. When the terminal 20 is a personal computer, this exchange can be done by means of a Web application which is active on the customer loyalty development server 30. The customer loyalty development server comprises means of communicating with the set of terminals 20 of the customer loyalty development system 10, and means of exchange with the members and with the affiliates. The customer loyalty development server 30 furthermore contains the database of the members 100, the database of the affiliates 110, and the database of the customer loyalty development strategies 120. A terminal 20 installed at a point of sale may be used in the customer loyalty development strategy of several affiliates. The messages 40, 50 exchanged between the terminals 20 and the customer loyalty development server 30 are lightweight asynchronous messages of a Web application. Unlike heavyweight messages, which, during a transaction of a Web application, return the whole of the information page, lightweight asynchronous messages convey only the data useful to the transaction. The messages 40, 50 typically have a length of 50 bytes and make it possible to execute a transaction in less than 12 ms. The applicant has developed a customer loyalty development application in which a Web application is executed on the terminals 20, in conjunction with the customer loyalty development server 30 through an Internet connection.

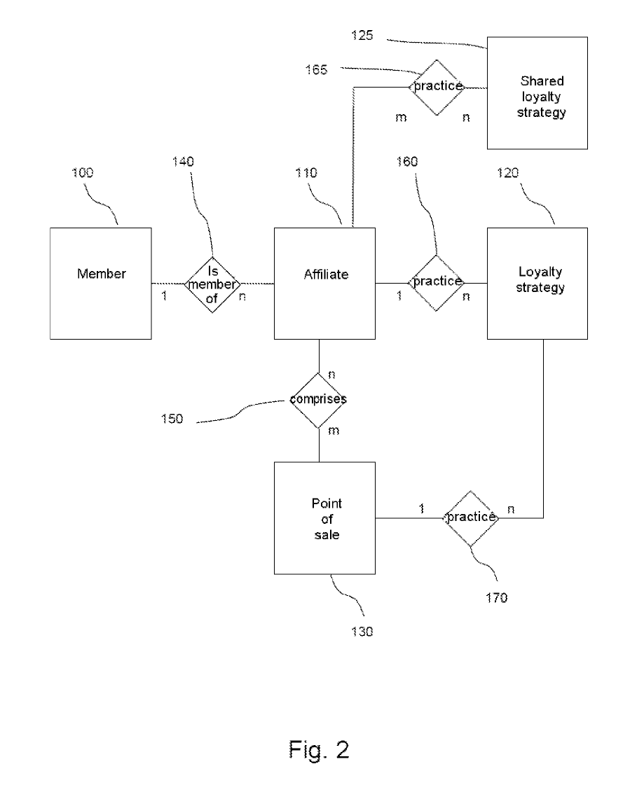

FIG. 2 is an entity-relationship chart representative of the structure of the databases residing on the customer loyalty development server 30. The database of the members 100 contains for each member his unique identifier, which may be a barcode. The database of the members 100 can also contain individual data such as the name of the member, his address and other data. The database of the affiliates 110 contains, for each affiliate, his unique identifier and individual data. A member-affiliate relationship 140 identifies for each member, the affiliate or affiliates with which he is associated, that is to say the commercial networks in which he has performed at least one transaction. This relationship 140 contains, for each member, and for each affiliate with which the member is associated, a counter of the points that the member has been allocated during his transactions with this affiliate. This relationship may optionally also contain the identity of a loyalty strategy—or of a shared loyalty strategy discussed hereinafter—applicable by this affiliate to this member. An affiliate may therefore thus decide to favor some of its members by applying a particular loyalty strategy to them. This assignment may be applied in an immediate manner, with immediate effect over the whole of the affiliate's commercial network. The database of the affiliates 110 is associated with a database of the points of sale 130, by a “comprises” relationship 150, by which each affiliate is associated with at least one point of sale. A given point of sale may also be associated with several affiliates.

A database of the customer loyalty development strategies 120 defines all the possible customer loyalty development actions and their parameters. For example, a strategy may provide for the granting of a certain number of points during each purchase, the number of points being dependent on the monetary amount of the purchases. The strategy can also allocate a certain number of points during a purchase beyond the n^{th} purchase. The database initially contains a certain number of “model-strategies”, and each affiliate or even each point of sale can select and parametrize its own strategies, by copying and by adapting the “model-strategies”. The links between affiliates and points of sale on the one hand and the customer loyalty development strategies 120 on the other hand, are embodied by the “practice” relationships 160, 170. An affiliate practices at least one customer loyalty development strategy, but may practice several, to be chosen in accordance with the circumstances specific to the purchase, or the type of member concerned. On the other hand, a given strategy, with its parameters, is practiced by a single affiliate only. Only the latter can access his parameters and can update them. He does not have access to the customer loyalty development strategies of the other affiliates of the customer loyalty development system. Likewise, a point of sale can define the parameters of the customer loyalty development strategies that it practices. In the absence of a customer loyalty development strategy associated with a point of sale, it is the strategy of the affiliate with which it is associated that is used.

In an optional manner, the database of the customer loyalty development server 30 can also contain shared customer loyalty development strategies 125. A “practice shared strategy” relationship 165 then indicates which group of m affiliates practices a given shared loyalty strategy. By virtue of this option, it is possible to define commercial actions linking several chains, for example a chain of supermarkets and a chain of gas stations. In an analogous manner (but not represented in FIG. 2 so as not to clutter it), the points of sale 130 may be associated with shared loyalty strategies 125.

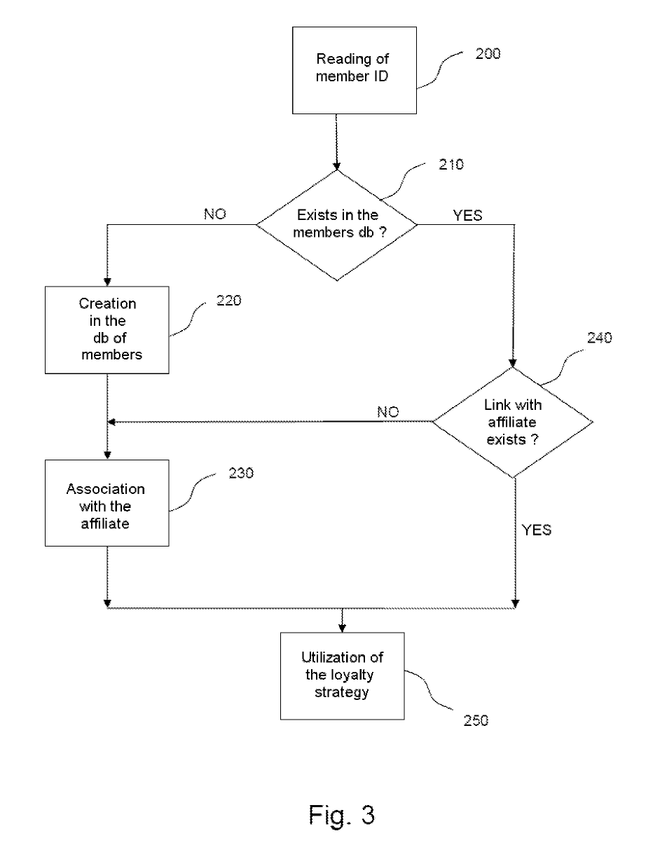

FIG. 3 shows diagrammatically the procedure executed when a transaction is performed at a point of sale. When the purchaser (the client) goes to the till, he provides the vendor with his unique identification means. During the first step, this unique identification means is read by the terminal 20. When the identification means is a barcode card or a chip card, the terminal 20 has suitable reading means. If the client does not have such a card, the vendor has blank, unallocated, cards and provides him with one. The unique identification means can also be a biometric characteristic of the client, such as his fingerprints or his iris. In this case, the terminal 20 has a suitable reader. A message 40 is exchanged with the customer loyalty development server 30.

This message contains the unique identifier of the member, the identifier of the affiliate, the identifier of the point of sale and the data relating to the transaction performed, such as the article(s) purchased, their selling price, the date. During the test 210, the existence of this member in the database of the members 100 is checked. If the client is unknown in the database of the members 100, a record is created during step 220. The member's individual data such as his name and his address, may be input by the vendor or by the client himself. Likewise, during step 230, an element of the member-affiliate relationship 140 is created, and contains the counter of points allocated to this member during the transactions performed at this affiliate. This points counter is normally initialized to zero, but it may be appreciated that a customer loyalty development strategy assigns an initial number, different from zero, of “welcome” points. If the client is known in the database of the members 100, a check is made, during the test 240, to verify whether he has already performed a transaction at this affiliate. If such is not the case, step 230 of creating an element of the member-affiliate relationship 140, as described hereinabove, is executed. Finally, in all cases, during step 250, the customer loyalty development server 30 utilizes the data relating to the member, to the affiliate, to the point of sale, and to the associated customer loyalty development strategy or strategies so as to determine the benefits allocated to the member. These benefits can comprise the allocating of a certain number of points (the points counter contained in the element of the member-affiliate relationship 140 is then incremented), the allocating of an immediate price reduction, the printing of a coupon representative of a benefit, the allocating of a gift, or other benefits. The allocating of the benefit can also be carried out on the basis of other elements, for example, chance, during a competition, or for the 1000^{th} client. On completion of the operation of utilizing the loyalty strategy 250, a message 50 may be dispatched by the customer loyalty development server 30 to the terminal 20. This message contains in particular the benefits accorded to the member. The benefit allocated to the member can be communicated to him for example by display on the screen of the terminal 20, or during the printing of a till receipt.

As represented in FIG. 1, an affiliate can access the customer loyalty development server 30, and undertake updates, represented by the message 70, of the record of the database of the affiliates 110, of the records of the database of the points of sale 130 and of the records of the database of the customer loyalty development strategies 120 which are specific to it. It can thus, through a Web application residing on the customer loyalty development server 30, modify in a flexible and fast manner, and with immediate effect, the data of its customer loyalty development policy. Likewise, the affiliate can obtain reports 80, containing statistics on its sales, on the number of points allocated, on its clients, or any other form of report. The Web application residing on the server is designed to prohibit access by an affiliate to the data of another affiliate. The implementation of these applications of consulting and updating the data of the database, once the structure of the device and of the database are known, poses no difficulties to an IT engineer. The screen for access by a member to his data can for example prompt him with the following options:

My actions in progress;
My log;
My trades;
My cards.
The design of access screens for an affiliate poses no more difficulties of implementation to an IT engineer.

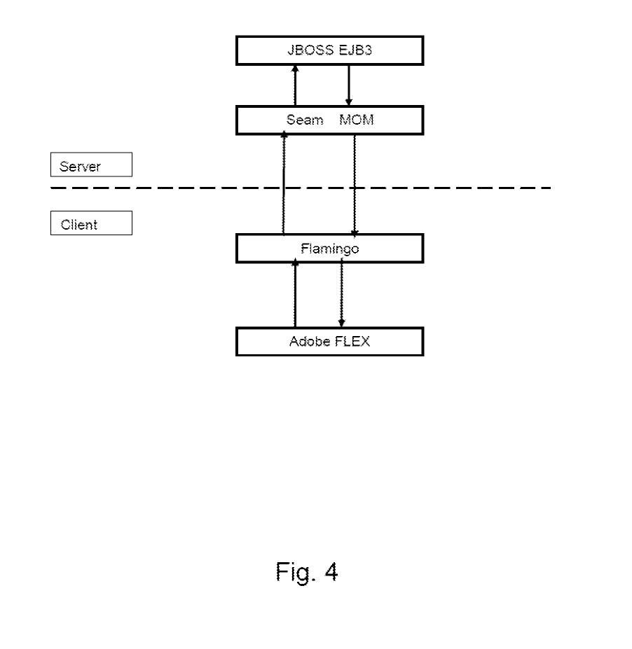

FIG. 4 is a block diagram representing the architecture of the software components used in an embodiment of a device of the invention in which the terminal 20 is a personal computer. The “client”, that resides in the terminal 20, is a client of a Web application, termed a “heavyweight client” that is to say, by contrast with Web applications in which html screens are fully refreshed upon each modification of data or formatting of the latter, in the application described, only the data modified by the transaction are exchanged over the network. The Adobe FLEX and Flamingo tools have been used for the creation of the flash application of the client. The Flamingo component creates and manages the lightweight asynchronous messages, that is to say those containing only the data actually modified during the transaction, and manages the Internet link. On the server, the Seam software is “Message-oriented middleware” (MOM) which handles the transport of the messages. The JBOSS EJB3 tool has been used to develop the data processing proper of the customer loyalty development application. Other tools may of course also be suitable for developing the application, for example it would be possible to use IBM MQ Series as MOM. It would be possible to use Glass FX or ICE FX for the development of the heavyweight client.

In another embodiment of the invention, the terminal 20 may be a dedicated terminal comprising a microcontroller on which resides software controlling on the one hand the reading of the identification means, and on the other hand, the exchanges with the server. In this case also, the messages exchanged with the server are lightweight asynchronous messages. The javacard and javamobile software may be used to develop the application on this microcontroller.

The customer loyalty development device 10 in accordance with the invention also makes it possible to produce reports intended for the member. These reports are schematically represented in FIG. 1 by the message 60, and can take several forms. The customer loyalty development server can print periodically, or on the occurrence of significant events, such as the exceeding of a points threshold, a detailed report, which is dispatched by post. The member can also access a Web application residing on the customer loyalty development server 30, and providing him with the same data. The member thus has, either on paper, or on screen, all of the points that he has been allocated during his transactions with one or each of the affiliates with which he has performed at least one transaction. Through this same Web application, the member can update his individual data. Thus there is therefore a single update, from which each of the affiliates of the system draws advantage.

The customer loyalty development device 10 in accordance with the invention relies on the possibility of exchanging messages 40, 50 between the terminal 20 of a point of sale and the customer loyalty development server 30, in real time, during the transaction. It may happen, however, that either the communication network used, or the customer loyalty development server 30 are out of service for a limited duration. In this case, the terminal 20 can provide for means of temporary storage of the transactions performed during the fault. When service is restored, the transactions are forwarded to the server and processed as described hereinabove. There is therefore no risk of the member losing points.

In the structure of the customer loyalty development device 10 in accordance with the invention, numerous benefits may be obtained and numerous variants may be implemented without difficulty. In a first example, the point of sale may be a commercial Internet site. The terminal 20 is then embodied by the server of said commercial site. The latter is then programmed to exchange messages 40, 50 with the customer loyalty development server 30. The identification of the member can be done either by inputting a member identifier, or through the presence of a “cookie” on the member's personal computer. In a second example, distinct affiliates can team together in association in a common customer loyalty development and promotion campaign in which a transaction performed with any one of the associated affiliates will trigger the allocating of points which are common to this association.

The device and the method in accordance with the invention, based on the principle of the single loyalty card for the client and of a computerized platform, enables traders to manage their customer loyalty development programs in complete independence, to keep their client database updated and to make the entire process more dynamic both for the trader and for the client. For the client, the unique loyalty card, the management of his data and the personalized information that he receives relating to the benefits to be garnered or collected is a service entirely free of charge. The member who goes to an affiliate for the first time is immediately recognized, without it being necessary to allocate him a number or to gather his individual data. When a member loses his identification card, it suffices to get him a new one, bearing the same identification code, in order for him to retrieve all his data, including his already allocated points. A member can even have several identical or distinct identification cards. For the trader, the customer loyalty development process is managed automatically according to his pre-set, but easily alterable, parameters. The device is usable both by affiliates having large networks of points of sale and numerous clients, and by lone traders, having only a single point of sale. In the latter case, the device and the method of the invention make it possible to propose elaborate customer loyalty development strategies, without excessive costs. The use of a centralized customer loyalty development server makes it possible to secure the data thereof in an effective manner.

The applicant has therefore noted that, by contrast with the known systems in which customer loyalty development counters are recorded on the loyalty card, it was possible to produce an effective and efficacious customer loyalty development device, based on Web tools and a centralized server. Even for an extended network, and even in a period of intense commercial activity, the server of the invention meets the demand within very satisfactory times.

The terms and descriptions used here are proposed by way of illustration only and do not constitute limitations. The person skilled in the art will recognize that numerous variations are possible within the spirit and scope of the invention such as is described in the claims which follow and their equivalents; in the latter, all the terms should be understood within their broadest acceptance, unless indicated otherwise.

1. A method for developing customer loyalty for a set of members of one or more affiliates, the method comprising:
allocating a unique identification means to each member of the set;
providing a terminal at one or more points of sale of the one or more affiliates, the terminal comprising a means for acquiring the identification of the member;
providing a customer loyalty development server configured to communicate with the terminal, and comprising a database of the members, a database of the affiliates and a database of the customer loyalty development strategies, wherein a customer loyalty development strategy is associated with a single affiliate, or with a point of sale of an affiliate;
during a transaction at a point of sale, dispatching, by the terminal from the point of sale to the customer loyalty development server, a message containing an identity of the member, an identity of the point of sale and/or of the affiliate and data relating to the transaction performed; and
allocating, by the customer loyalty development server, a number of points to a points counter specific to the member and to the affiliate.

2. The method according to claim 1, further comprising:
dispatching, by the customer loyalty development server, statement message to the terminal.

3. The method according to claim 2, wherein the message and/or the statement message are lightweight asynchronous messages.

4. The method according to claim 1, wherein the unique identification means contains only the unique identification of the member to the exclusion of other data.

5. The method according to claim 1, wherein the unique identification means is selected from the group consisting of a barcode element, a magnetic-track card, a chip card, an identity card fitted with a chip, a radio-frequency tag, and biometric identification means.

6. The method according to claim 1, wherein the customer loyalty development server is configured to allow an affiliate to consult and update a fraction of the database of the customer loyalty development strategies which relates to it.

7. The method according to claim 1, wherein the customer loyalty development server is configured to produce and to forward, to one or more members, a report established regarding the number of points obtained by the member.

8. A device for developing customer loyalty for a set of members of one or more affiliates, the device comprising:
for each member of the set, a means of unique identification of this member;
at each point of sale of an affiliate, a terminal comprising a means for reading the unique identification of the member;
a customer loyalty development server configured to communicate with each of said terminals, and comprising a database of the members, a database of the affiliates and a database of the customer loyalty development strategies;
means for dispatching, during a transaction at a point of sale, by the terminal from the point of sale to the customer loyalty development server, a message containing an identity of the member, an identity of the point of sale and/or of the affiliate and data relating to the transaction performed; and
means for allocating, by the customer loyalty development server, a number of points to a points counter specific to the member and to the affiliate.

9. The device according to claim 8, wherein the customer loyalty development server and each of the terminals are configured to communicate with one another by means of lightweight asynchronous messages.

10. The device according to claim 8, wherein the means of unique identification of a member contains only the unique identification of the member to the exclusion of other data.

11. The device according to claim 8, wherein the identification means is selected from a group consisting of a barcode element, a magnetic-track card, a chip card, an identity card fitted with a chip, a radio-frequency tag, and biometric identification means.

12. The device according to claim 8, wherein the customer loyalty development server is configured to provide an affiliate with a consultation and update application for a fraction of the database of the customer loyalty development strategies which relates to it.

13. The device according to claim 8, wherein the customer loyalty development server is configure to produce and to forward, to one or more members, a report established regarding the number of points obtained by the member.

14. A non-transitory computer-readable storage medium, on which a computer program is stored which, after being loaded into a memory of a terminal, enables the terminal to execute fraction residing on the customer loyalty development server of the method according to claim 1.

15. A non-transitory computer-readable storage medium, on which a computer program is stored which, after being loaded into a memory of a terminal, enables the terminal to execute a fraction residing on the terminal of the method according to claim 1.

16. The method according to claim 5, wherein the biometric identification means comprises one or more fingerprints or an iris.

17. The device according to claim 11, wherein the biometric identification means comprises one or more fingerprints or an iris.
